(19) United States
(12) Patent Application Publication
(10) Pub. No.: US 2004/0013432 A1
(43) Pub. Date: Jan. 22, 2004

(54) Direct backside optical fiber attachment to microprocessor chips

(76) Inventors: Tanay Karnik, Portland, OR (US); Jianping Xu, Portland, OR (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/197,046

(22) Filed: Jul. 16, 2002

(51) Int. Cl. H04J 14/02

(52) U.S. Cl. 398/88

(57) ABSTRACT

According to embodiments of the invention described herein, a system and apparatus are described that include a microprocessor that has light-emitting devices formed into it. The light-emitting devices are to emit lightwaves, or optical signals, that may be organized into optical data. An optical fiber, connected directly to the microprocessor, is to accept the light from the light-emitting devices on the microprocessor die and to transmit the optical data to other devices in a system.

### FIELD

The present invention relates generally to the field of microprocessor input/output (I/O) devices and, more specifically, to optical fibers in conjunction with microprocessors and I/O devices.

### BACKGROUND

Today's microprocessor systems operate at very high clock rates—in the multi-gigahertz (GHz) frequencies. However, despite the very fast clock speeds, conventional microprocessors are limited by slow data transfer rates off the chip because of interconnect discontinuities and electrical losses, which are illustrated in FIGS. 1A-1C below.

FIGS. 1A-1C illustrate a conventional microprocessor chip utilizing conventional I/O interfaces. In FIG. 1A, a front-side of conventional microprocessor die 100 is shown. Power pins 102 are placed in the middle 103 of the die 100 to minimize power grid impedance and to achieve efficient power delivery to the die. Consequently, die I/O pins 104 are on the outer perimeter 105 of the die 100. FIG. 1B shows the backside 106 of the conventional microprocessor die 100 whereupon active electronic devices 101 (e.g., transistors, flash memory cells, etc.) are formed in relation to the die I/O pins 104.

FIG. 1C shows a conventional microprocessor assembly 120 including the microprocessor die 100 described above contained in a package 122. The microprocessor package 122 has package I/O pins 123 that connect to a printed circuit board (PCB) 130. The PCB 130 includes a long electrical PCB trace 132 for some package I/O pin 123. The long electrical PCB trace 132 terminates at another connection 142 connecting the long electrical PCB trace 132 to an off-board device such as a jumper, or a laser 144, as shown in FIG. 1C. The laser 144 converts electrical data traveling through the long electrical PCB trace 132 into optical data. A lens 146 can focus the optical data into an optical fiber 148.

Still referring to FIG. 1C, the microprocessor die 100 is connected to a package substrate 126 at the die I/O pins 104. Each connection has an accompanying electrical package trace 128 running through the package substrate 126. The electrical package traces 128 terminate at the package I/O pins 123. Impedance losses, reflection losses, dielectric losses, and skin effect losses (“electrical losses”) are introduced by the distance and high frequencies that electrical signals travel while passing through the electrical package traces 128. Each type of electrical loss (impedance, reflection, dielectric, skin effect, etc.) is well understood in the art and must be considered when designing interconnects. Furthermore, the long electrical PCB trace 132 may be longer than 10 inches to reach an off-board connector, such as the laser 144. Additionally the long electrical PCB trace 132 results in electrical losses.

In addition, discontinuities 150 are introduced where the electrical package traces 128 connect to the die I/O pins 104, where the electrical package traces 128 connect to package I/O pins 123, and where the PCB trace 132 connects to the laser 144. Discontinuities are physical variations in the material that makes connections between circuit elements, such as solder points or other anomalies. The physical variations in the discontinuities also interfere with the continuous flow of electrical signals through the connections. As a result, discontinuities 150, just like electrical losses, also reduce the electrical signal bandwidth.

Some techniques have been employed to compensate for the loss of electrical signals in the traces and at discontinuities. Those techniques include upsizing I/O driving circuits on the microprocessor die to drive the data through the trace distances and through discontinuities. Upsizing I/O devices, however, requires having to deliver more power to the microprocessor, thus resulting in increased power consumption. In addition, upsizing I/O devices can only compensate for some of the electrical losses, not all of them.

### BRIEF DESCRIPTION OF THE DRAWINGS

Embodiments of the present invention are illustrated by way of example and should not be limited by the figures of the accompanying drawings in which like references indicate similar elements and in which:

FIGS. 1A-1C illustrate a conventional microprocessor chip utilizing conventional I/O interfaces.

FIG. 2 is an illustration of a microprocessor assembly according to one embodiment of the present invention.

FIG. 3 is a light-emitting device according to one embodiment of the invention.

FIG. 4 is a light-emitting device according to another embodiment of the invention.

FIGS. 5A-5B illustrate a microprocessor assembly according to another embodiment of the present invention.

FIG. 6 illustrates a system according to one embodiment of the invention.

FIG. 7 illustrates a computer system according to one embodiment of the invention.

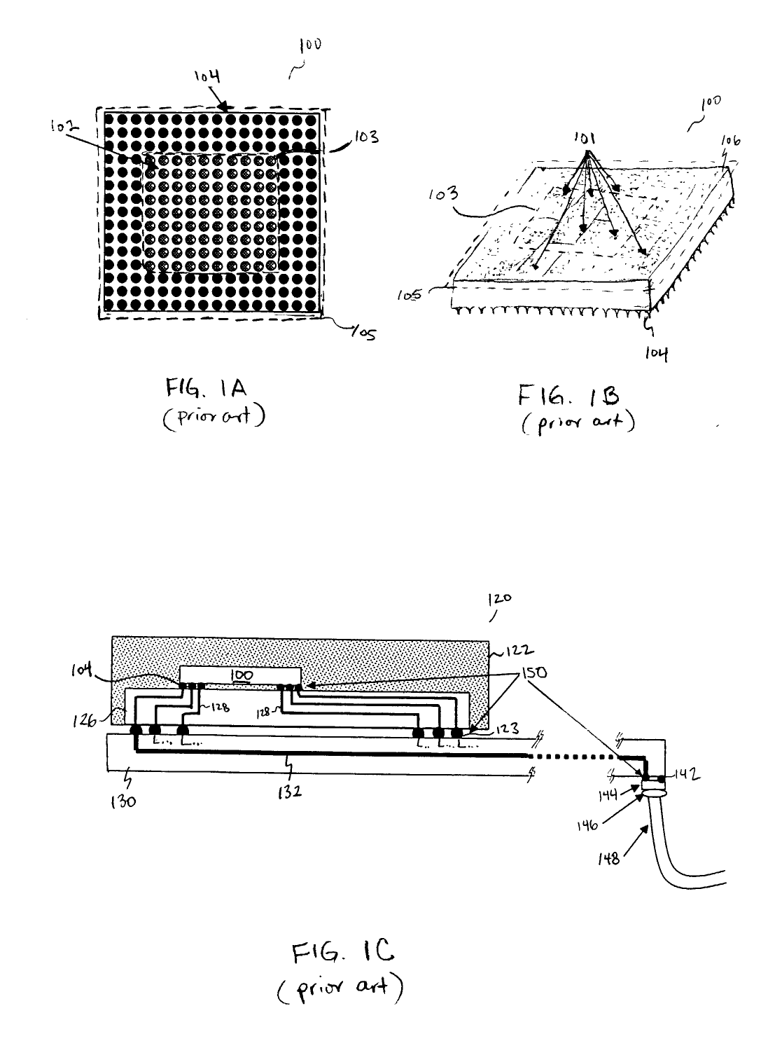

### DETAILED DESCRIPTION

Described herein is a system and apparatus for a direct backside optical fiber attachment to a microprocessor chip. In the following description numerous specific details are set forth. One of ordinary skill in the art, however, will appreciate that these specific details are not necessary to practice embodiments of the invention. While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

According to embodiments of the invention described herein, a system and apparatus are described that include a microprocessor that has light-emitting devices formed into it. The light-emitting devices can emit light-waves that carry optical data. The optical data produced by the light-emitting devices does not have to travel through a series of metal trace lines and discontinuities to communicate with other electronic devices on a system or a network. Rather, the optical data can be received directly from another microprocessor or die by an optical fiber connected to the light-emitting microprocessor and a photodetector. The optical fiber may be integrated into, or used in place of, data buses in a computer system or in place of metal (e.g., coaxial) cables in a network.

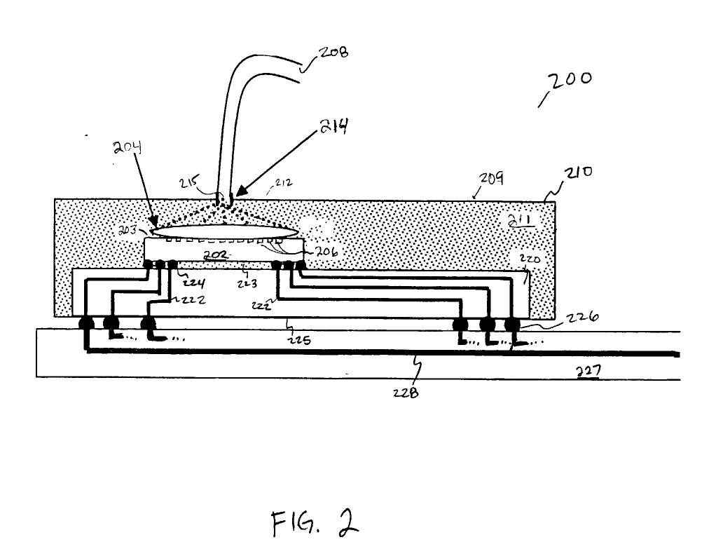

FIG. 2 is an illustration of a microprocessor assembly 200 according to one embodiment of the present invention. FIG. 2 includes a microprocessor die 202 with a lens 204 connected to the backside 203 of the die 202. The microprocessor die 202 includes at least one light-emitting device 206 that can covert electrical signals into light. In one embodiment, there may be a plurality of light-emitting devices 206, as shown in FIG. 2. In one embodiment of the invention, the light-emitting device 206 may include a silicon-based light-emitting diode (“Si-LED”) to create lightwaves having wavelengths anywhere between approximately 800 nm to 1600 nm with frequencies ranging up to hundreds of terahertz. In another embodiment of the invention, the light-emitting device 206 may include a Si-LED modulator and serializer to emit optical signals and organize it into optical data. Modulators will enable high speed communication.

The lens 204 is to capture the light from the light-emitting device 206 and focus the light into an optical fiber 208. The microprocessor die 202 may be covered by a casing 209 and contained in a medium 211 that is transparent to the wavelength of light emitted form the light-emitting device 206. In one embodiment of the invention, the medium 211 may be a vacuum of air and the casing 209 may be a hard material to protect the die 202 or other delicate elements of a microprocessor. The casing 209, medium 211, and any other element that surrounds the microprocessor processor die 202 or connects the microprocessor die 202 to the circuit board, may be referred to herein collectively as a microprocessor package, or simply as a package 210. The package 210 has an outer boundary 212 to which the optical fiber 208 can be attached. One ordinarily skilled in the art will recognize that packages can comprise a variety of configurations (e.g., dual-in-line, pin-grid array, plastic land grid array, organic land grid array, etc.) and materials (e.g., ceramics, organics, etc.) that may differ in appearance and constitution to the package 210 shown in FIG. 2, but that can also be used in conjunction with embodiments of the invention.

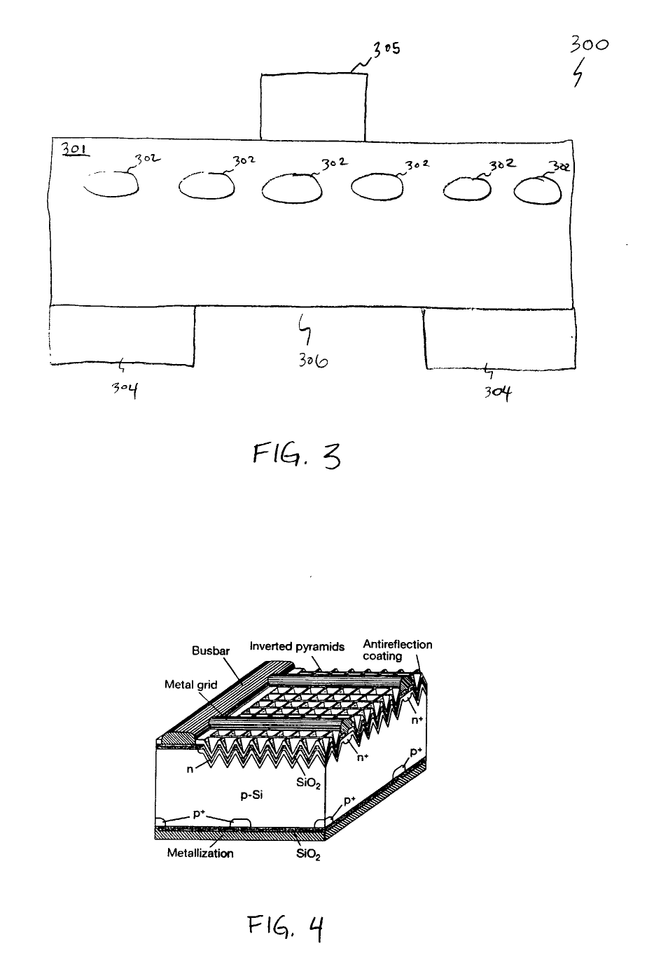

According to one embodiment of the invention, the light-emitting device 206 may include a silicon-based light-emitting diode, or a Si-LED. A Si-LED may be formed according to any well-known method in the art. According to one approach, as shown in FIG. 3, a Si-LED 300 is formed by implanting ions of a certain conductivity, such as p-type dopants, into a substrate 301 doped to a different conductivity, such as n-type silicon, and annealing the substrate 301 to form dislocation loops 302. For example, boron may be implanted at a dose of 1.1015 cm⁻² at an energy of 30 keV into an n-type silicon substrate 301 and annealed in a nitrogen atmosphere for 20 minutes at 1,000° C. to form an array of dislocation loops 302. The dislocation loops 302 introduce a local strain field, which provides spatial confinement of charge carriers. The spatial confinement of charge carriers allows for room temperature electroluminescence of the dislocation loops 302. After implantation and annealing, AuSb eutectic ohmic contacts 304 may be attached to the back of the substrate 301 and a 1 mm AI ohmic contact 305 may be attached to the front of the substrate 301. Ohmic contacts 304 and 305 may be sintered at 360° C. for 2 min. When a voltage difference is applied between front and back ohmic contacts 304 and 305, the dislocation loops 302 experience electroluminescence, or in other words, the dislocation loops 302 convert electron energy to lightwaves. A window 306 allows the lightwaves created by the dislocation loops 302 to escape from the backside of the silicon substrate 301. Further details may be obtained by referring to Ng, W. L. et al., “An efficient room-temperature silicon based light-emitting diode.” Nature 410, 192-194 (2001).

The Si-LED 300 described above can produce lightwaves at an approximate wavelength of 1130 nm directly in silicon using a regular CMOS fabrication process. The Si-LED 300 operates at room temperatures and has a positive thermal gain in electroluminescence, or in other words, the optical power increases with increasing temperature.

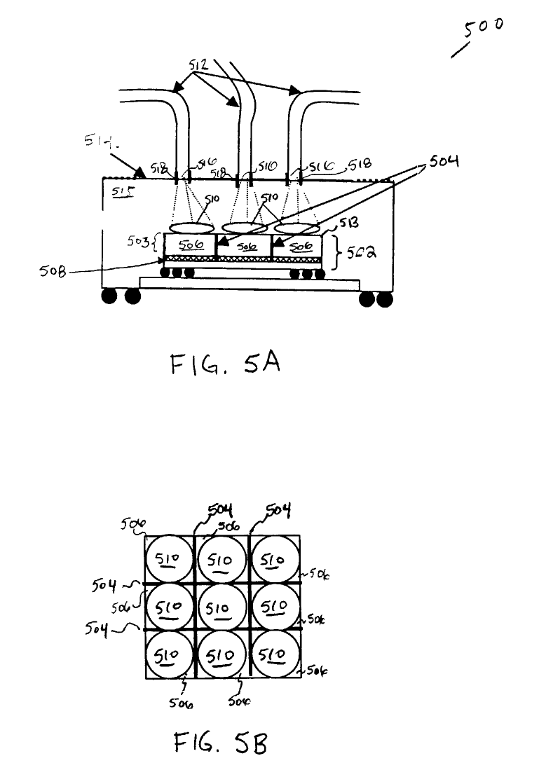

Other approaches well known in the art may be utilized as well to improve the light-emitting performance of the Si-LED. In Green, M. A. et al., “Efficient silicon light-emitting diodes.” Nature 412, 805-808 (2001), a Si-LED may be formed by increasing the natural ability of a semiconductor to absorb and emit radiation by etching an array of inverted pyramids into the backside of a silicon substrate, as shown in FIG. 4. The pyramids reflect absorbed lightwaves back into the semiconductor and increase the factor of lightwave emission dramatically. Furthermore, light emission can be improved by utilizing special surface treatments, small contacts and selective doping.

In one embodiment of the invention, the light-emitting device 206 may include a silicon based light-emitting diode modulator (“Si-LED modulator”). A Si-LED modulator is a combination of a Si-LED and an electroptical modulator. The Si-LED can convert electrical signals, such as from active devices on the silicon die 202, directly into lightwaves and the modulator can vary the brightness, or intensity, of the lightwaves. The Si-LED modulator can also combine modulated lightwaves with a carrier signal at a certain frequency. Modulated lightwaves can be characterized as optical data bits, or in other words bits of data in the form of light flashes, as opposed to levels of electron current or voltage potential. A serializer may be combined with the Si-LED modulator to organize the optical data bits into an optical data stream, or in other words to organize and/or multiplex the data bits into one or more series (“streams”) of bits of optical data that can be transferred via an optical fiber. Complex streams of optical data can therefore be emitted from the light-emitting device 206. Optical data can be organized into frequencies that match the clock-rates of conventional microprocessor, which clock-rates are currently in the multi-GHz ranges and steadily climbing.

Consequently, in one embodiment of the invention, the light-emitting device 206 may emit modulated and serialized lightwaves, or in other words, optical data. However, since both lightwaves and optical data are forms of light energy, they may both be respectively referred to herein as “light” unless specified otherwise.

Referring back to FIG. 2, the lens 204 can capture light emitted from the light-emitting device 206 and focus the light into an optical fiber 208. The lens 204 is affixed in proximity to the backside 203 of the processor die 202 to focus the light emitted from the light-emitting device 206. In one embodiment of the invention, as shown in FIG. 2, the lens is touching the processor die 202, but the lens does not necessarily have to touch the processor die 202. As long as the lens 204 can accept the light from the light-emitting device 206, the lens 204 may be affixed anywhere within the package 210. It should also be noted that the term “backside” is a relative term that traditionally has meant the “substrate” side of a microprocessor die wherein the active devices are formed, and, more specifically, the bottom of the silicon substrate upon which an integrated circuit has been formed. By contradistinction, the “frontside” 223 would be the top side where metal contact pads are formed. Therefore, as shown in FIG. 2, the term “backside” follows the traditional definition and is shown as the side of the microprocessor die 202 in closest proximity to the light-emitting device 206 so that the light from the device 206 is not obstructed by other devices within the microprocessor die 202. In FIG. 2, the light-emitting device 206 is configured to emit light through the backside 203 of the processor die 202 where the active devices (e.g., transistors) of an integrated circuit reside. However, it is conceivable that a light-emitting device 206 may be configured on the processor die so that the light-emitting device 206 may emit light from almost any side of the microprocessor die 202. Consequently, the lens 204 would need to be positioned within the package 210 to accept the light from the light-emitting device 206 according whichever side of the processor die 202 the light was emitting from.

In one embodiment of the invention, the lens may be a material that will act as a conductor of heat created by the microprocessor die 202. For example, the lens 204 may be comprised of Silica glass, which is a heat conductor. Therefore, lens 204 is to act as a heat-sink to absorb heat produced by the microprocessor die 202 or any devices thereon, including absorbing heat produced by the light-emitting device 206.

Still referring to FIG. 2, the optical fiber 208 must be affixed so that the end 215 will not move from the focal point of the lens 204. In one embodiment of the invention, the optical fiber 208 is attached to a boundary 212 of the casing 209 of the package 210 directly above the lens 204. The end 215 of the optical fiber should coincide with the focal point of the lens 204 so that when light is emitted from a device 206, the light can be focused directly into the optical fiber 208. As shown in FIG. 2, the boundary 212 of the casing 209 is parallel to the backside 203 of the processor die 202 and the fiber is centrally affixed over the die 202 and the lens 204. However, one ordinarily skilled in the art will recognize that such a configuration can be altered and still function similarly. For example, the lens 202 may be angled so that the focused light is transmitted to a focal point that is not directly above the processor die 202. Instead, the lens 204 may be angled so that the focal point is elsewhere. Consequently, the optical fiber 208 would need to be affixed to a position so that the end 215 of the optical fiber 208 would coincide with the focal point of the angled lens. In addition, it should be understood that the boundary 212 of the casing 209 need not be uniformly planar as shown in FIG. 2.

The optical fiber 208 may be attached to the package 210 by etching an opening 214 in the casing 209 of the package 210, inserting the end 215 of the optical fiber 208 into the opening 214 and affixing the optical fiber 208 into the opening 214. An epoxy resin may be used to affix the optical fiber 208 in the opening 214. The epoxy resin should adhere to the material of the optical fiber 208 and to the material of the casing 209 of the package 210.

Consequently, an advantage of the microprocessor assembly 200 is that light (i.e., lightwaves and optical signals/data) can be created directly on the microprocessor die 202 and driven, via the shortest path possible, from the microprocessor die 202 directly to the attached optical fiber 208 without having to subject the optical signals to package and board level discontinuities and losses that would occur with electrical signals. As a result, microprocessor assembly 200 can have an extremely low data loss compared to a conventional electrical trace microprocessor assembly. For example, the microprocessor assembly 200 has no frequency dependant losses as commonly occur in metal trace wires as a result of skin effect since optical fibers do not experience skin effect as metal trace wires do. Furthermore, optical fibers can transfer optical data without experiencing impedance and dielectric losses as metal trace wires do. Therefore, data may be transmitted from the microprocessor assembly 200 at a very high data rate.

Still referring to FIG. 2, the microprocessor assembly 200 may further include a package substrate 220 contained within the package 210. The package substrate 210 may include electrical traces 222 connected to power or I/O die pins 224 on the frontside 223 of the processor die 202. The electrical traces 222 run from the die pins 224 to power or I/O package pins 226 connected to the underside 225 of the package substrate 220. The package pins 226 can be connected to a printed circuit board (PCB) 227. Additionally, the PCB may include long electrical PCB traces 228.

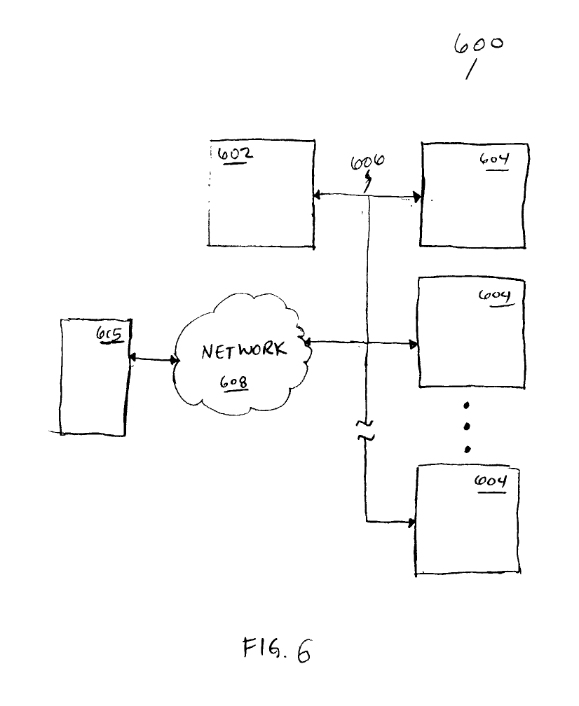

FIGS. 5A-5B illustrate a microprocessor assembly 500 according to another embodiment of the present invention. FIG. 5A shows a cross-sectional side view of a microprocessor assembly 500 having a processor die 502 having a layer 503, on the backside of the substrate, with a plurality of partitions 504 to divide the layer 503 into compartments 506. Each compartment 506 is to confine light for one or more light-emitting devices contained in the active area 508 of the microprocessor die 502. Each individual compartment 506 may have an individual lens 510 dedicated to focusing light contained within the individual compartment 506, and an individual optical fiber 512 may be dedicated to accepting the focused light from each individual lens 510. FIG. 5B is backside view of the processor die 502 showing a lens array formed according to the embodiment of FIG. 5A. Each lens 510 is affixed in proximity to its accompanying compartment 506. As shown in FIG. 5A, the lenses are attached to the microprocessor die 502, however need not be touching or attached to the processor die 502 as long as they can effectively accept the light contained in the compartments 506. In other embodiments, the lenses 510 may be embedded in the processor die 502.

The individual compartments 506 may be very useful for isolating regions on the processor die 502 that contain functional units of the microprocessor. Such functional units may include arithmetic logic units (ALUs), address generation units (AGUs), register files, buffers, schedulers, caches, etc., all of which are carefully designed configurations of active devices (transistors, flash cells, etc.) in the active area 508. Any of the microprocessor's functional units may have at least one I/O pin to which other circuit elements can be connected and accept electrical signals created by the functional unit. The I/O pin may include a light-emitting device connected thereto to emit optical data. The compartment 506 would therefore be to keep the emission of optical data from one functional unit from interfering with the emission of optical data from a neighboring functional unit. If not for the light partitions 504, the light (i.e., photons) from neighboring units would blend together and the optical data would experience “photonic” noise. Furthermore, it should be noted that the package 514 should be an opaque material that will block ambient light from entering the enclosure in which the microprocessor die 502 is contained.

Referring to FIG. 5A, the optical fibers 512 are affixed to the package 514 so that the ends 516 are affixed to the focal points of the lenses 510. The optical fibers 512 may be attached to the package 514 by etching openings 518 in the package 514, inserting the ends 516 of the optical fibers 512 into the openings 518 and affixing the optical fibers 512 into the openings 518. An epoxy resin may be used to affix the optical fibers 512 into the openings 518. The epoxy resin should adhere to the material of the optical fiber 512 and to the material of the package 514. The lenses 510 may comprise a material that can absorb heat produced by the microprocessor die 502 so that lenses 510 can act as heat sinks to the microprocessor 500.

Still referring to FIG. 5A, the light partitions 504 may be formed in the backside 513 of the microprocessor die 502, directly into the silicon substrate. According to one embodiment of the invention, the light partitions 504 comprise a material that will reflect or absorb light and contain it within a particular compartment to thus prevent the light from interfering with light contained in neighboring compartments. In one embodiment of the invention, the light partitions 504 may be an oxide, such as silicon dioxide (SiO₂), which can be formed into a silicon substrate according to well-known techniques. According to one embodiment of the invention, the light partitions 504 may be formed utilizing techniques for forming through vias and backside probe trenches. As shown in FIG. 5A, the light partitions 504 extend from the outer boundary of the layer 503 downward in a directly vertical manner until the light partitions 504 meet the active area 508. However, the light partitions 504 do not have to be configured exactly as shown as long as they effectively contain light within the compartment 506.

FIG. 6 shows a system 600 according to one embodiment of the invention. The system 600 may include an electronic device 602 having I/O communication capabilities and any other devices 604 capable of receiving data from, or transmitting data to, the unit 602. Devices 604 may include electronic, optic, electroptical, or other similar devices. The electronic device 602 includes at least one light-emitting device to emit lightwaves, optical signals, or optical data, according to any of the embodiments of the invention described herein, hence electronic device 602 may herein be referred to as a light-emitting electronic device 602. According to specific embodiments described herein, the light-emitting electronic device 602 has been described as a microprocessor, or light-emitting microprocessor, since light-emitting devices have been shown to be formed directly onto the backside of a microprocessor, however other electronic units that are not microprocessors also have integrated circuitry that has been formed into a silicon substrate. Hence, the light-emitting electronic device 602 should not be limited to a microprocessor, but may be any communication I/O device, chip, integrated-circuit, electronic device or electro-optical device from which electronic, optical, or other forms of communication signals may be formed, stored, or extracted and upon which a light-emitting device may be formed. An optical fiber 606 is connected directly to the light-emitting electronic device 602 and is to accept and transmit optical data between the light-emitting electronic device 602 and the devices 604. In one embodiment, the optical fiber 606 may be connected directly to any one of the devices 604. In another embodiment, the optical fiber 606 may be connected to a network 608, such as an optical data network, which will transmit the data over a long distance and deliver the data to a device 605 connected to the network 608. Exemplary systems 600 include a computer system (desktop, laptop, personal digital assistant, etc.), a network system (router, switch, bridge, etc.), a telecommunications system (cellular phone, landline phone, etc.) or other electronic systems utilizing a microprocessor.

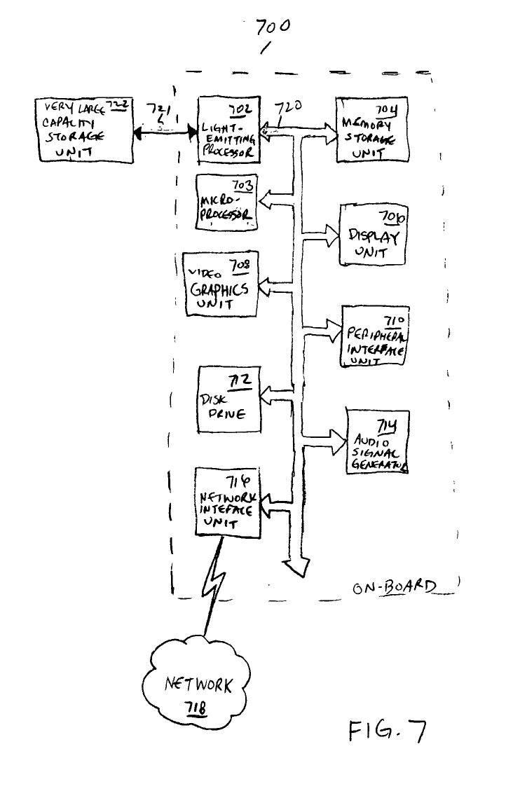

FIG. 7 illustrates a computer system 700 according to one embodiment of the invention. Referring to FIG. 7, computer system 700 includes a light-emitting microprocessor 702 connected to a plurality of on-board devices such as another microprocessor 703, a memory storage unit 704 (e.g., main memory and a static memory), a video display unit 706 (e.g., a monitor), a video graphics unit 708 (e.g., PCI, AGP, etc), an interface unit for peripherals 710 (e.g., keyboard, mouse, printer, etc.), a disk drive unit 712, an audio signal generator unit 714 (e.g., a speaker), or a network interface unit 716 to connect to a network 718. An optical fiber 720 connected directly to the light-emitting microprocessor 702 may be utilized in place of one or more types of data buses (e.g., front side bus, memory bus, AGP bus, etc.) typically connecting electronic units in a computer system. In addition, the light-emitting microprocessor 702 may be directly connected to an off-board device, such as a very large capacity memory storage unit 722 via another optical fiber 721 also connected directly to the light-emitting microprocessor 702. The very large capacity memory storage unit 722 may be a relatively long distance (e.g., several meters) from the light-emitting microprocessor 702, yet because of the direct optical fiber connection to the light-emitting microprocessor 702, optical data may be transmitted between the light-emitting microprocessor 702 and the very large capacity memory storage unit 722 at a very high data rate.

Several embodiments of the invention have thus been described. However, those ordinarily skilled in the art will recognize that the invention is not limited to the embodiments described, but can be practiced with modification and alteration within the spirit and scope of the appended claims that follow.

What is claimed:

1. An apparatus, comprising:
a microprocessor having a light-emitting device; and
a lens to capture and focus light from the light-emitting device.

2. The apparatus of claim 1, further comprising:
an optical fiber to accept the focused light from the lens.

3. The apparatus of claim 2, further comprising a package casing, the optical fiber being connected to the package casing.

4. The apparatus of claim 1, wherein the light-emitting device includes a silicon light-emitting diode (Si-LED) to covert electrical signals into lightwaves.

5. The apparatus of claim 1, wherein the light-emitting device includes a Si-LED modulator to convert electrical signals into optical data-bits.

6. The apparatus of claim 5, further comprising a serializer to organize the optical data bits into an optical data stream.

7. The apparatus of claim 1 wherein the lens is to act as a heat sink to the microprocessor die.

8. A microprocessor, comprising:
a silicon substrate; and
a light-emitting device formed into the backside of the silicon substrate.

9. The microprocessor of claim 8, wherein the light-emitting device includes a Si-LED modulator to convert electrical signals into optical data-bits and a serializer to organize the optical data-bits into an optical data-stream.

10. The microprocessor of claim 9, further comprising:
a lens to accept and focus the optical data-stream into an optical fiber.

11. The microprocessor of claim 10 wherein the lens is to act as a heat sink to the microprocessor.

12. The microprocessor of claim 8, further including light partitions to divide the backside of the substrate into a plurality of individual compartments, each individual compartment to confine light emitted from one or more light-emitting devices.

13. The microprocessor of claim 12, wherein the light partitions comprise silicon dioxide (SiO₂).

14. The microprocessor of claim 12, comprising a plurality of individual lenses, each individual lens to focus the confined light for an individual compartment into one of a plurality of optical fibers.

15. A system, comprising:
an electronic device including a light-emitting device to emit optical signals; and
an optical fiber connected directly at one end to the electronic device, the optical fiber to accept the optical signals emitted by the electronic device and to transmit the optical signals.

16. The system of claim 15, wherein the electronic device is a microprocessor including a package and the optical fiber is connected to the package.

17. The system of claim 15, wherein the electronic device includes a Si-LED modulator to convert electrical signals from active devices on the electronic device into optical data-bits and a serializer to organize the optical data-bits into an optical data-stream.

18. The system of claim 15, further comprising:
a second electronic device to accept the light transmitted from the optical fiber.

19. The system of claim 18, wherein the second electronic device is any one of a memory storage unit, a video graphics unit, an I/O interface unit, a drive unit, a network interface unit, an audio signal generation unit, a microprocessor, or a very large capacity memory storage unit.

20. The system of claim 18, further comprising a network wherein any one of the optical fiber or the second electronic device is connected to the network.
